(19) United States
(12) Patent Application Publication
(10) Pub. No.: US 2026/0127852 A1
(43) Pub. Date: May 7, 2026

(54) BALANCED GENERATIVE IMAGE MODEL TRAINING

(71) Applicant: Shutterstock, Inc., New York, NY (US)

(72) Inventors: Raúl Gómez Bruballa, Dublin (IE); Alessandra Sala, Dublin (IE)

(21) Appl. No.: 18/935,979

(22) Filed: Nov. 4, 2024

(51) Int. Cl. G06V 10/764; G06V 20/70

(52) U.S. Cl. CPC G06V 10/764; G06V 20/70

(57) ABSTRACT

A method for training an image generation model includes receiving a first set of training data comprising multiple training images and corresponding image captions, using the first set of training data to perform a first training process to train the image generation model resulting in a trained image generation model, and defining sensitive categories and protected attributes associated with the training images. The method further includes using the sensitive categories and the protected attributes to generate a second set of training data that is balanced across at least one of the protected attributes with respect to at least one of the sensitive categories, and using the second set of training data to perform a second training process to de-bias the trained image generation model resulting in a de-biased image generation model.

### TECHNICAL FIELD

The present disclosure generally relates to image generation, and particularly to training of image generative models.

### BACKGROUND

The data requirements to train machine learning and/or artificial intelligence (AI) image generation models are immense, involving very large training image datasets. However, all generative AI models have inherent biases and imbalances that are representative of and inherited from the image datasets they are trained on. Since the social impact of generative AI is potentially large, it is important to ensure that the generated data distribution doesn’t replicate or augment sensitive biases, by amplifying stereotypes (e.g., gender stereotypes, racial stereotypes, etc.).

Studies have demonstrated that current image generation models do suffer from these biases (e.g., Leonardo Nicoletti and Dina Bass, “Bloomberg Analysis of Stable Diffusion,” https://www.bloomberg.com/graphics/2023-generative-ai-bias/, retrieved January 17, 2024). Image sets generated for every high-paying job were dominated by subjects with lighter skin tones, while subjects with darker skin tones were more commonly generated by prompts like “fast-food worker” and “social worker.” For each image depicting a perceived woman, almost three times as many images were generated of perceived men. Most occupations were dominated by men, except for low-paying jobs like housekeeper and cashier. Men with lighter skin tones represented the majority of subjects in every high-paying job, including “politician,” “lawyer," “judge” and “CEO.” The biases in image generation models are worse than reality, with women being underrepresented in high-paying occupations and overrepresented in low-paying ones, and overrepresenting people with darker skin tones while underrepresenting people with lighter skin tones in low-paying fields.

As such, there is a need for optimizing the training of generative image models to counter sensitive biases.

Some embodiments of the present disclosure provide a method for receiving a first set of training data including a group of training images and corresponding image captions, and using the first set of training data, performing a first training process to train the image generation model resulting in a trained image generation model. The method further includes defining a group of sensitive categories associated with the group of training images and further defining a group of protected attributes associated with the group of training images. The method further includes, using the group of sensitive categories and the group of protected attributes, generating a second set of training data that is balanced across at least one of the group of protected attributes with respect to at least one of the group of sensitive categories, and using the second set of training data, performing a second training process to de-bias the trained image generation model resulting in a de-biased image generation model.

Some embodiments of the present disclosure provide a non-transitory computer-readable medium storing a program for training an image generation model, which when executed by a computer, configures the computer to receive a first set of training data including a group of training images and corresponding image captions, and using the first set of training data, perform a first training process to train the image generation model resulting in a trained image generation model. The program, when executed, further configures the computer to define a group of sensitive categories associated with the group of training images, define a group of protected attributes associated with the group of training images, and using the group of sensitive categories and the group of protected attributes, generate a second set of training data that is balanced across at least one of the group of protected attributes with respect to at least one of the group of sensitive categories. The program, when executed, further configures the computer to, using the second set of training data, perform a second training process to de-bias the trained image generation model resulting in a de-biased image generation model.

Some embodiments of the present disclosure provide a system for training an image generation model, having a processor and a non-transitory computer-readable medium storing a set of instructions, which when executed by the processor, configure the system to receive a first set of training data including a group of training images and corresponding image captions, and using the first set of training data, perform a first training process to train the image generation model resulting in a trained image generation model. The instructions, when executed, further configure the computer to define a group of sensitive categories associated with the group of training images, define a group of protected attributes associated with the group of training images, and using the group of sensitive categories and the group of protected attributes, generate a second set of training data that is balanced across at least one of the group of protected attributes with respect to at least one of the group of sensitive categories. The instructions, when executed, further configure the computer to, using the second set of training data, perform a second training process to de-bias the trained image generation model resulting in a de-biased image generation model.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement model training, according to some embodiments.

FIG. 2 is a block diagram illustrating details of a system for model training, according to some embodiments.

FIG. 3 is a flowchart illustrating a process for balanced model training, according to some embodiments.

FIG. 4 is a block diagram that illustrates training of an image generation model, according to some embodiments.

FIG. 5 is a block diagram that illustrates generation of balanced refinement data, according to some embodiments.

FIG. 6 is a block diagram that illustrates an iteration of fine-tuning an image generation model, according to some embodiments.

FIG. 7 is a flowchart illustrating a process for iteratively fine-tuning an image generation model, according to some embodiments.

FIG. 8 is a block diagram that compares inference using a baseline model to inference using a de-biased model, according to some embodiments.

FIG. 9 is a block diagram illustrating an exemplary computer system with which aspects of the subject technology can be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

All references cited anywhere in this specification, including the Background and Detailed Description sections, are incorporated by reference as if each had been individually incorporated.

The term “sensitive category” as used herein refers, according to some embodiments, to categories of people that are subject to stereotypes, such as but not limited to personalities, conditions, actions, income levels, occupations, and socioeconomic status. Generally, sensitive image categories may be any category in which there is interest or need in correcting protected attributes biases, and therefore related to people.

For example, personalities may include but are not limited to fun, angry, depressed, etc. Actions may include, but are not limited to, winning, running, speaking, serving, cleaning, running, explaining, and the like. Socioeconomic status may include entrepreneur, working class, heirs/heiresses, and the like. Income levels may be qualitatively defined by relative descriptions such as low-income, high-income, etc., or quantitatively defined according to salary amounts or ranges. Conditions may include, but are not limited to, prisoners, debtors, judged, and the like. Occupations may include, but are not limited to, higher-paying occupations such as architects, lawyers, corporate executives (CEO, etc.), doctors, and the like; lower-paying occupations such as teachers, housekeepers, cashiers, janitors, dishwashers, fast-food workers, retail workers, social workers, and the like; and professional occupations like scientists, politicians, judges, engineers, and the like. Occupations may also be of a criminal nature, including but not limited to inmates, prisoners, drug dealers, terrorists, and the like.

The term “protected attribute” as used herein refers, according to some embodiments, to attributes of people which are the basis for applying stereotypes and biases, and which are often protected against discrimination by law. Protected attributes may include, but are not limited to, gender, skin color (e.g., quantitatively characterized by a metric such as the Fitzpatrick Skin Scale, qualitatively characterized by relative descriptions such as shades of “light” or “dark,” etc.), race, ethnicity, age, religion, and the like.

The term “image generation model” as used herein refers, in some embodiments, to artificial intelligence-based (AI) and/or machine learning (ML) models designed to generate image output based on text, image, audio, video, or other digital media inputs. These models employ various techniques including, but not limited to, diffusion models, latent diffusion models, generative adversarial networks (GANs), variational autoencoders (VAEs), autoregressive models, and transformer-based architectures. The terms “image generator” and “generative image model” may be used equivalently herein to refer to image generation models. As used herein, image generation models are also understood by persons of ordinary skill in the art to include video generative models that generate video output.

The term “loss function” as used herein refers, according to some embodiments, to mathematical functions that are used in the training of image generation models. These functions quantify the discrepancy between the model’s predictions and the ground truth (i.e., the training data) to guide an iterative optimization process, enabling the trained model to generate accurate and diverse output images. Examples of loss functions for image generation models include, but are not limited to, mean squared error (MSE), cross-entropy, Wasserstein distance, and Kullback-Leibler (KL) divergence. The term “reconstruction loss” may be used herein to refer to the discrepancy between the model’s predictions and the ground truth during a single iteration of the training process.

The term “reconstruction loss” may be equivalently used herein to refer to the discrepancy between the model’s predictions and the ground truth during a single iteration of the training process.

The term “optimization loss” as used herein refers, according to some embodiments, to an overall objective of minimizing the discrepancy being measured by the loss function to improve the model’s performance. In other words, the loss function evaluates individual predictions and guiding model adjustments, and the optimization loss seeks to minimize error across the entire training dataset, by iteratively adjusting model parameters during training.

Image generation models may be conditioned to different information instead of or combined with text. An example of conditioning image generation models to additional information (equivalently referred to herein as “micro-conditioning” or “fine-tuning”) is provided in U.S. Patent Application 18/919,866 (“Conditioned Image Generation”), filed on October 18, 2024, and incorporated herein by reference.

An example of conditioning image generation models to counter inherent biases in training data is provided in U.S. Patent No. 12,106,548 (“Balanced Generative Image Model Training”), issued on October 1, 2024, and incorporated herein by reference.

Embodiments of the present disclosure address the above identified problems by de-biasing an image generation model to counter a set of sensitive biases.

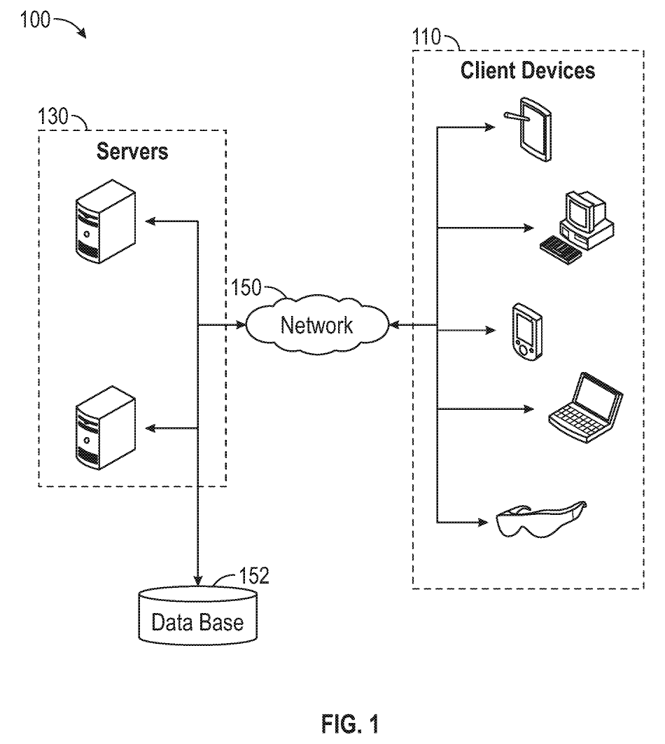

FIG. 1 illustrates a network architecture 100 used to implement model training, according to some embodiments. The network architecture 100 may include one or more client devices 110 and servers 130, communicatively coupled via a network 150 with each other and to at least one database, e.g., database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). Moreover, the network 150 may include one or more of a local area network (LAN), a wide area network (WAN), the Internet, and the like. Furthermore, the network 150 may include, but is not limited to, any one or more of the following network topologies, including a bus network, a star network, a ring network, a mesh network, and the like.

In some embodiments, the client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include at least some of the client devices 110 as well, such that they are peers.

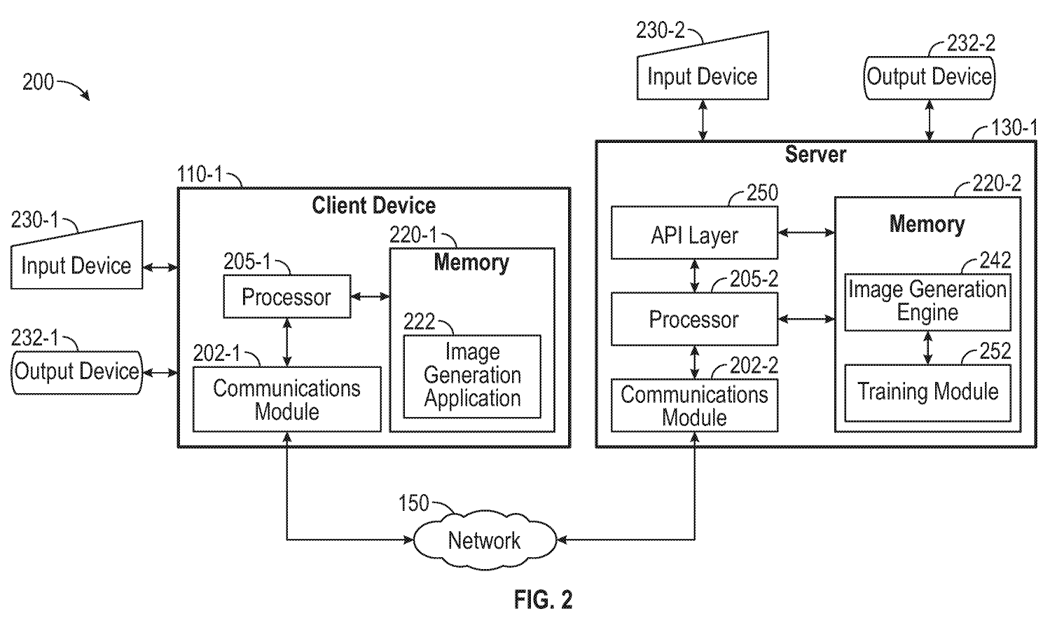

FIG. 2 is a block diagram illustrating details of a system 200 for model training, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include processors 205-1 and 205-2 and memories 220-1 and 220-2, respectively. Processors 205-1 and 205-2 and memories 220-1 and 220-2 will be collectively referred to, hereinafter, as “processors 205” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display, a touchscreen display also used as an input device, a speaker, an alarm, and the like. A user may interact with client device 110-1 and/or server 130-1 via the input devices 230 and the output devices 232.

Memory 220-1 may further include an image generation application 222, configured to execute on client device 110-1. The image generation application 222 may be downloaded by the user from server 130-1 or may be hosted by server 130-1. The image generation application 222 may include specific instructions which, when executed by processor 205-1, cause operations to be performed consistent with embodiments of the present disclosure. In some embodiments, the image generation application 222 runs on an operating system (OS) installed in client device 110-1. In some embodiments, image generation application 222 may run within a web browser. In some embodiments, the processor 205-1 is configured to control a graphical user interface (GUI) (e.g., spanning input device 230-1 and output device 232-1) for the user of client device 110-1 to access and interact with image generation application 222.

In some embodiments, memory 220-2 includes an image generation engine 242. The image generation engine 242 may include one or more image generation models that may be configured to perform methods and operations consistent with embodiments of the present disclosure.

The image generation engine 242 may share or provide features and resources with the client device 110-1, including data, libraries, and/or applications (e.g., image generation application 222). The user may access the image generation engine 242 through the image generation application 222. The image generation application 222 may be installed in client device 110-1 by the image generation engine 242 and/or may execute scripts, routines, programs, applications, generative text and image models, and the like provided by the image generation engine 242. In some embodiments, image generation application 222 may communicate with image generation engine 242 through an API layer 250. In some embodiments, the processor 205-2 is configured to control a graphical user interface (GUI) (e.g., spanning input device 230-2 and output device 232-2) for a user of server 130-1 to access and interact with image generation engine 242.

In some embodiments, memory 220-2 includes training module 252. The training module 252 may be configured to perform methods and operations consistent with embodiments of the present disclosure. For example, training module 252 may perform a training process on one or more image generation models executed by the image generation engine 242. The training module 252 may use training data either stored in memory 220-2 or retrieved from an external database (e.g., database 152) to perform the training process on the image generation models executed by the image generation engine 242.

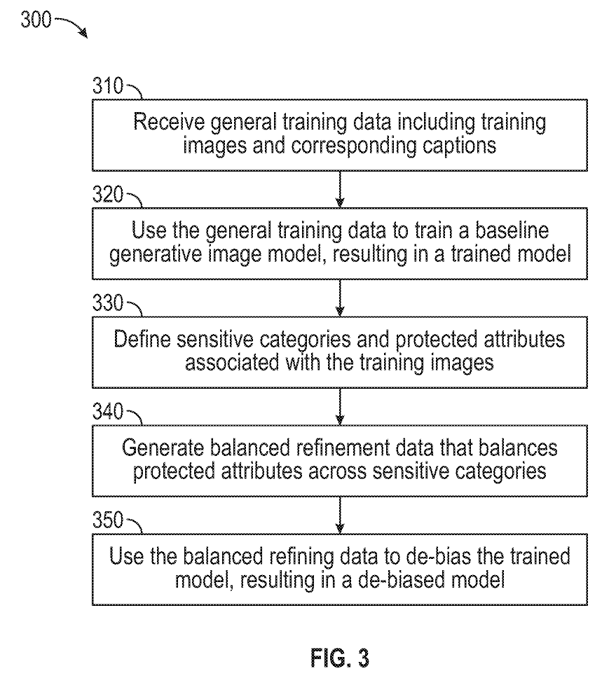

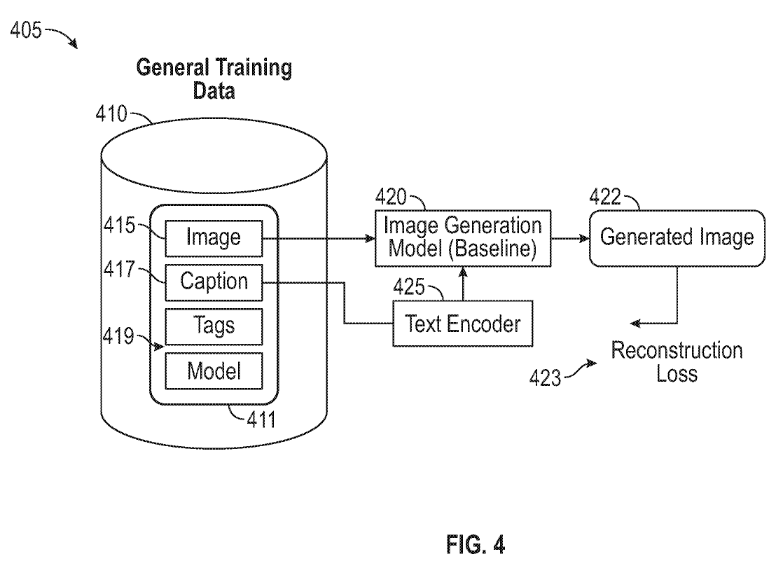

FIG. 3 is a flowchart illustrating a process 300 for balanced model training performed by a client device (e.g., client device 110-1, etc.) and/or a client server (e.g., server 130-1, etc.), according to some embodiments. In some embodiments, one or more operations in process 300 may be performed by a processor circuit (e.g., processors 205, etc.) executing instructions stored in a memory circuit (e.g., memories 220, etc.) of a client device (e.g., client device 110-1) and/or a server (e.g., server 130-1) of a system for model training (e.g., system 200, etc.) as disclosed herein. For example, various operations in process 300 may be performed by image generation application 222, image generation engine 242, training module 252, or some combination thereof. Moreover, in some embodiments, a process consistent with this disclosure may include at least operations in process 300 performed in a different order, simultaneously, quasi-simultaneously, or overlapping in time. The process 300 will be further described with reference to the example of FIGS. 4 to 8, which are described further below.

At 310, the process 300 receives a first set of training data (also referred to as “general training data”), that includes a first set of images for training, and corresponding image captions. At 320, the process 300 uses the general training data to train an image generation model.

FIG. 4 is a block diagram that illustrates training of an image generation model, according to some embodiments. In the example of FIG. 4, a training pipeline 405 is shown that uses general training data 410 having multiple training images, of which an exemplary training image 411 is shown in more detail. The training image 411 includes image data 415, an associated image caption 417, and one or more features 419. In this non-limiting example, the features include but are not limited to tags and model-specific data. The tags may describe, for example, protected attributes and/or sensitive categories associated with image data 415. The image caption 417 and/or the features 419 may be stored as metadata tags (e.g., as entries within a header structure) of the image data 415, stored alongside the image data 415 in a same storage, or retrieved from an external database (e.g., database 152, according to some embodiments).

The general training data 410 may be used to train an image generation model 420. The image generation model 420 may be a baseline image generation model that has not undergone any previous iterations of training or conditioning, or a pre-trained image generation model that has already undergone at least one iteration of training and/or conditioning.

Using the general training data 410 as an input, the image generation model 420 outputs one or more generated images 422, which are then compared to the ground truth images (e.g., image data 415) using a loss function (not shown). A reconstruction loss 423 is computed using the loss function and used to optimize the variables of the image generation model 420. This training process is repeated until the reconstruction loss 423 is below a certain threshold or meets other stopping criteria (e.g., using various image metrics).

The reconstruction loss 423 (also referred to as an optimization loss) may be calculated by various methods, including but not limited to image subtraction in pixel space, a vector difference in a vector representation space, a matrix difference, and the like. The training process optimizes the image generation model 420 to generate target images based on both an image prompt (corresponding to image captions such as image caption 417) and, optionally, to condition the image generation model 420 to other features (corresponding to features such as features 419). In some embodiments, the image generation model 420 may be conditioned on different types of information, i.e., a sketch, another image, etc., during the current training process, an earlier training process, or combination thereof.

During training, the image captions and features may need to be encoded and/or embedded so that it can be consumed by the image generation model being trained. In some embodiments, as illustrated with the example of FIG. 4, the image captions may be encoded using a text encoder 425. As an example, the text encoder 425 may be a large language model.

The image generation model 420 may be one of a Generative Adversarial Network (GAN), a Variational Autoencoder (VAE), an autoregressive model, a diffusion-based model, a transformer-based architecture, or other type of generative model. The image generation model 420 may be a generative model of a different modality, such as a video generation model. Furthermore, the image generation model 420 may already be optimized and/or conditioned to various features in the general training data.

Returning to FIG. 3, at 330, the process 300 defines sensitive categories and protected attributes associated with the training images. The protected attributes may include, but are not limited to, gender, skin color, race, ethnicity, age, and religion. The sensitive categories may include, but are not limited to, personalities, conditions, actions, income levels, occupations, and socioeconomic status. Generally, sensitive image categories may be any category in which there is interest or need in correcting protected attributes biases, and therefore related to people.

In some embodiments, the sensitive categories and protected attributes may be defined using an external model to annotate at least a subset of the images in the general training data. For example, the annotation may be performed using a classification operation. The classification operation may assign images in the general training data to predefined sensitive categories and protected attributes. Alternatively, the classification operation may be used to define the sensitive categories and protected attributes based on an analysis and/or processing of the images in the general training data.

At 340, the process 300 uses the sensitive categories and protected attributes to generate balanced refinement data that includes images and corresponding captions. Within the balanced refinement data, the distribution of some or all of the protected attributes are balanced in some or all of the sensitive categories. The balancing of protected attributes across sensitive categories may not be perfect, but approximate. In some embodiments, the balance may be limited to specific subsets of protected attributes and sensitive categories.

In some embodiments, generating the balanced refinement data includes annotating images with tags to associate each image with at least one sensitive category and at least one protected attribute. A selection operation may be performed on the annotated images, to achieve the desired balance of protected attributes across sensitive categories. The size of the balanced refinement data may be smaller than the size of the general training data, so that balancing is more feasible.

In some embodiments, the balanced refinement data may or may not be a subset of the general training data. Images that are candidates to be used for the balanced refinement data may be annotated with metadata, tags, and/or model-specific data. The selection operation may then be performed on the annotated candidates. The general training data used to train the baseline model may contain non-annotated images that would be discarded for the balanced refinement data.

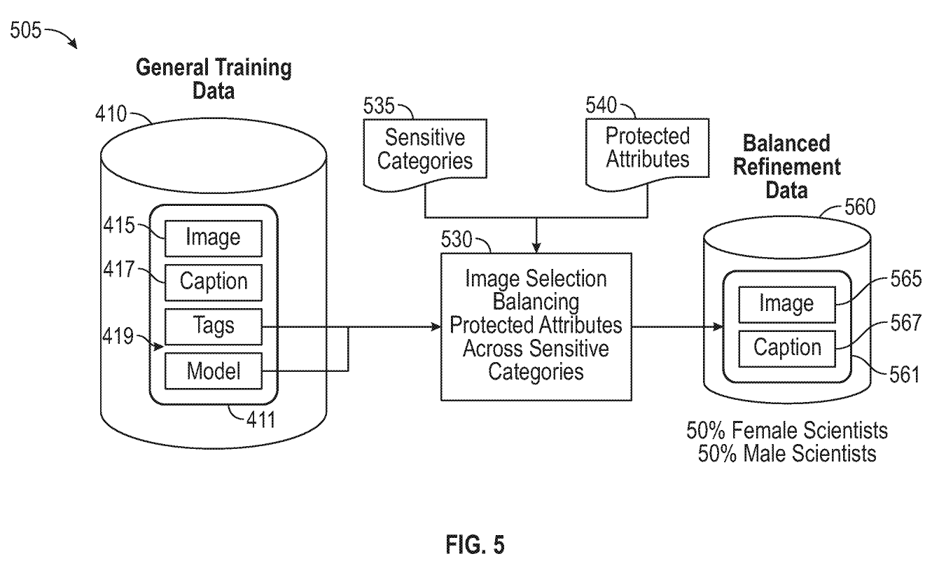

FIG. 5 is a block diagram that illustrates generation of balanced refinement data, according to some embodiments. In the example of FIG. 5, a selection pipeline 505 is shown that receives the general training data 410 (as described above with respect to FIG. 4) and performs a selection operation 530 on the training images therein. The selection operation 530 uses, as input, definitions of sensitive categories 535 and protected attributes 540. The selection operation 530 may also use as input image captions (e.g., image caption 417) and additional features (e.g., features 419).

The result of the selection operation is balanced refinement data 560 that includes multiple training images, of which an exemplary training image 561 is shown in more detail. The training image 561 includes image data 565 and an associated image caption 567. As an example of how the balanced refinement data 560 is balanced across the sensitive categories and protected attributes, the balanced refinement data 560 may contain the same number (or approximately the same number) of images depicting “female scientists” as those depicting “male scientists,” or the same number of engineers per ethnicity. In this example, the sensitive category is “scientist,” and the protected attribute is gender (male/female).

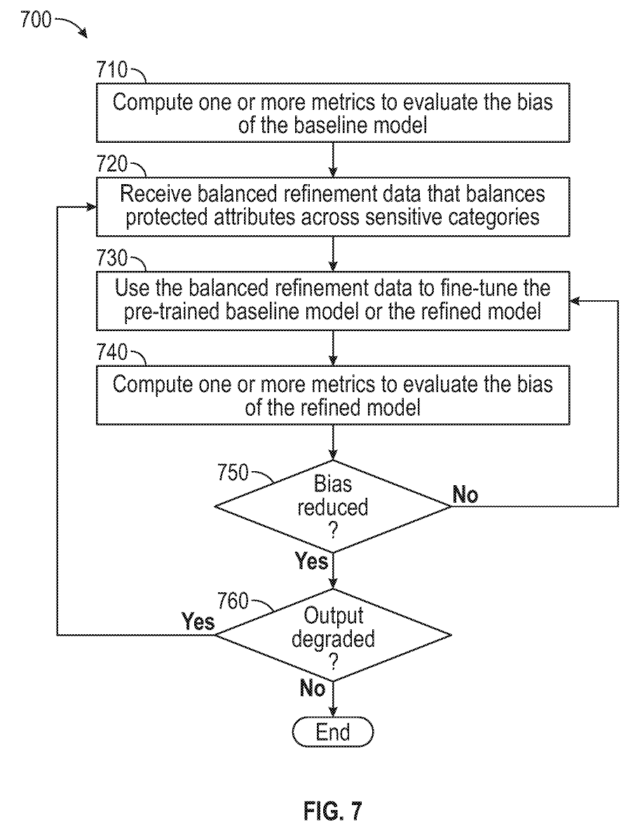

Returning to FIG. 3, at 350, the process 300 uses the balanced refinement data to de-bias the trained model, resulting in a de-biased model. In some embodiments, the model is de-biased by performing a fine-tuning process on the trained model. An example of a process 700 for fine-tuning is described below with reference to FIG. 7. The fine-tuning may be conducted with the same optimization method used to train the baseline model (i.e., reconstruction loss) or with a different one (i.e., adversarial loss).

In some embodiments, multiple fine-tuning epochs may be performed to iteratively refine the image generation model in order to achieve full de-biasing. For example, during the fine-tuning process, the refined model may be evaluated after each iteration, and various actions taken depending on the evaluation results in a feedback loop. During the fine-tuning process, the image generation model may be evaluated by computing a set of metrics in a test dataset that is withheld from the refining data. Iterations during the fine-tuning process may proceed until the protected attributes biases are negligible, and the rest of the metrics have not been harmed compared to the baseline model. Depending on the value of the various metrics during the iterations, further iterations of the fine-tuning process may be performed.

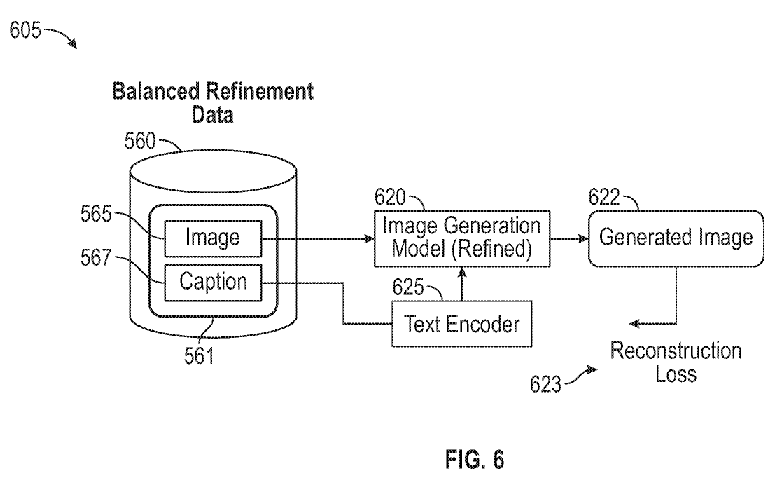

FIG. 6 is a block diagram that illustrates an iteration of fine-tuning an image generation model, according to some embodiments. In the example of FIG. 6, a fine-tuning pipeline 605 is shown that uses the balanced refinement data 560, as described above with respect to FIG. 5.

The balanced refinement data 560 may be used to train an image generation model 620. The image generation model 620 may be a baseline image generation model that has not undergone any previous iterations of fine-tuning (e.g., baseline image generation model 420), or a pre-refined image generation model that has already undergone at least one iteration of fine-tuning.

Using the balanced refinement data 560 as an input, the image generation model 620 outputs one or more generated images 622, which are then compared to the ground truth images (e.g., image data 565) using a loss function (not shown). A reconstruction loss 623 is computed using the loss function and used to optimize the variables of the image generation model 620. This training process is repeated until the reconstruction loss 623 is below a certain threshold or meets other stopping criteria (e.g., using various image metrics).

The reconstruction loss 623 (also referred to as an optimization loss) may be calculated by various methods, including but not limited to image subtraction in pixel space, a vector difference in a vector representation space, a matrix difference, and the like. The training process optimizes the image generation model 620 to generate target images based on an image prompt (corresponding to the image captions such as image caption 567). The image generation model 620 may also be conditioned to various features or other types of information (not shown), during the fine-tuning process, an earlier training process, or combination thereof.

During fine-tuning, the image captions and features may need to be encoded and/or embedded so that it can be consumed by the image generation model being fine-tuned. In some embodiments, as illustrated with the example of FIG. 6, the image captions may be encoded using a text encoder 625. As an example, the text encoder 625 may be a large language model.

The example of fine-tuning shown in FIG. 6 is conducted with the same optimization method used to train the baseline model (i.e., reconstruction loss) described with reference to FIG. 4 above. However, the fine-tuning may be conducted with a different optimization model (i.e., adversarial loss), in other embodiments.

The image generation model 620 may be one of a Generative Adversarial Network (GAN), a Variational Autoencoder (VAE), an autoregressive model, a diffusion-based model, a transformer-based architecture, or other type of generative model. The image generation model 620 may be a generative model of a different modality, such as a video generation model. Furthermore, the image generation model 620 may already be optimized and/or conditioned to various features in the balanced refinement data 560.

FIG. 7 is a flowchart illustrating a process 700 for iteratively fine-tuning an image generation model, performed by a client device (e.g., client device 110-1, etc.) and/or a client server (e.g., server 130-1, etc.), according to some embodiments. In some embodiments, some or all of the operations in process 700 may be performed as operation 350 of process 300, which is described above with reference to FIG. 3.

In some embodiments, one or more operations in process 700 may be performed by a processor circuit (e.g., processors 205, etc.) executing instructions stored in a memory circuit (e.g., memories 220, etc.) of a client device (e.g., client device 110-1) and/or a server (e.g., server 130-1) of a system for model training (e.g., system 200, etc.), as disclosed herein. For example, various operations in process 700 may be performed by image generation application 222, image generation engine 242, training module 252, or some combination thereof. Moreover, in some embodiments, a process consistent with this disclosure may include at least operations in process 700 performed in a different order, simultaneously, quasi-simultaneously, or overlapping in time.

At 710, the process 700 computes one or more metrics, to evaluate the bias of a baseline image generation model. In some embodiments, the metrics are computed using a test data set that is different from general training data used to pre-train the baseline model. The test data may be provided as input to the baseline model and the metrics applied to at least the outputs from the baseline model. Some non-limiting examples of metrics that may be used to evaluate the baseline model are described below:

Protected attribute biases: Measures how effective model debiasing has been for the baseline model. This metric may be evaluated by using the test data to generate a set of images of sensitive categories (i.e., scientist) and measuring their distribution across protected attributes (i.e., gender). As an example, if one hundred “scientist” images are generated, and 20% are female and 80% are male, the baseline model has a male bias in that category/protected attribute pair (scientist/gender).

Generic image generation metrics: Text-to-image model metrics.

Generated images diversity: Measures how diverse generated images are, for the same prompt.

Fréchet inception distance (FID): Measures generated image quality.

Contrastive Language-Image Pre-training (CLIP): Measures alignment of the generated image to the input prompt.

At 720, the process 700 receives balanced refinement data that is balanced across sensitive categories and protected attributes. The sensitive categories and protected attributes may be defined by operation 330 of process 300, in some embodiments. The balanced refinement data may be generated by operation 340 of process 300, in some embodiments.

At 730, the process 700 uses the balanced refinement data to fine-tune the baseline model (if the first fine-tuning iteration), or the refined model (in subsequent iterations). The fine-tuning may be performed using fine-tuning pipeline 605, as an example. The result of any single iteration of process 700 at 730 is a refined model that may be or may not be fully de-biased. In other words, multiple fine-tuning iterations at 730 may be needed to de-bias the refined model.

At 740, the process 700 computes one or more metrics to evaluate the bias of the refined model. In some embodiments, the metrics are computed using a test data set that is different from the balanced refinement data used to fine-tune the refined model. The test data may be provided as input to the refined model and the metrics applied to at least the outputs from the refined model. Some non-limiting examples of metrics that may be used to evaluate the refined model are described below.

Protected attribute biases: Measures how effective model debiasing has been for the refined model. This metric may be evaluated by using test data to generate a set of images of sensitive categories (i.e., scientist) and measuring their distribution across protected attributes (i.e., gender). As an example, if one hundred “scientist” images are generated, and 50% are female and 50% are male, the refined model doesn’t have bias in that category/protected attribute pair. Some threshold percentage may be defined to account for imperfect balance, such as 5% (e.g., a 55% / 45% balance).

Generic image generation metrics: Text-to-image model metrics.

Generated images diversity: Measures how diverse generated images are (for the same prompt). This may be used to measure if the model has overfit the refinement set.

Fréchet inception distance (FID): Measures generated image quality.

Contrastive Language-Image Pre-training (CLIP): Measures alignment of the generated image to the input prompt.

At 750, the process 700 evaluates the protected attribute biases metric to determine whether protected attribute biases have been reduced. The amount of bias may be assessed, for example, by comparing the value of the protected attribute biases metric to that of the baseline model (e.g., as evaluated above at 710). If the biases have not been reduced, the process 700 may return to 730 to perform another iteration of fine-tuning to further reduce the bias.

In some embodiments, if the biases are still high despite repeated fine-tuning iterations, the balanced refinement data may be adjusted. As an example, to compensate some biases of the baseline model (i.e., only 20% female scientist), the balance of the balanced refinement data may be altered with a correction factor to compensate the strong bias towards a given protected attribute (i.e., a distribution of 70% female scientist vs. 30% male scientist in the balanced refinement data). For example, the number of fine-tuning iterations (at 730) may be compared to a threshold number, and if the number of iterations exceeds that threshold, then a determination may be made to alter the balanced refinement data.

At 760, the process 700 evaluates the model quality and image diversity metrics to determine whether the output of the refined model is degraded (e.g., by overfitting the balanced refinement data). Degradation may be assessed by comparing the values of (at least) the model quality and/or image diversity metrics for the refined model to those of the baseline model (e.g., as evaluated above at 710). If the model quality and/or image diversity of the refined model are degraded relative to the baseline model, then the process may return to 720, to receive a larger set of balanced refinement data. The larger set of balanced refinement data may be generated by operation 340 of process 300, for example.

The process 700 ends when the refined model is fully de-biased, e.g., protected attributes biases are negligible or minimized, and the rest of the metrics have not been harmed compared to the baseline model, e.g., the output has not been degraded.

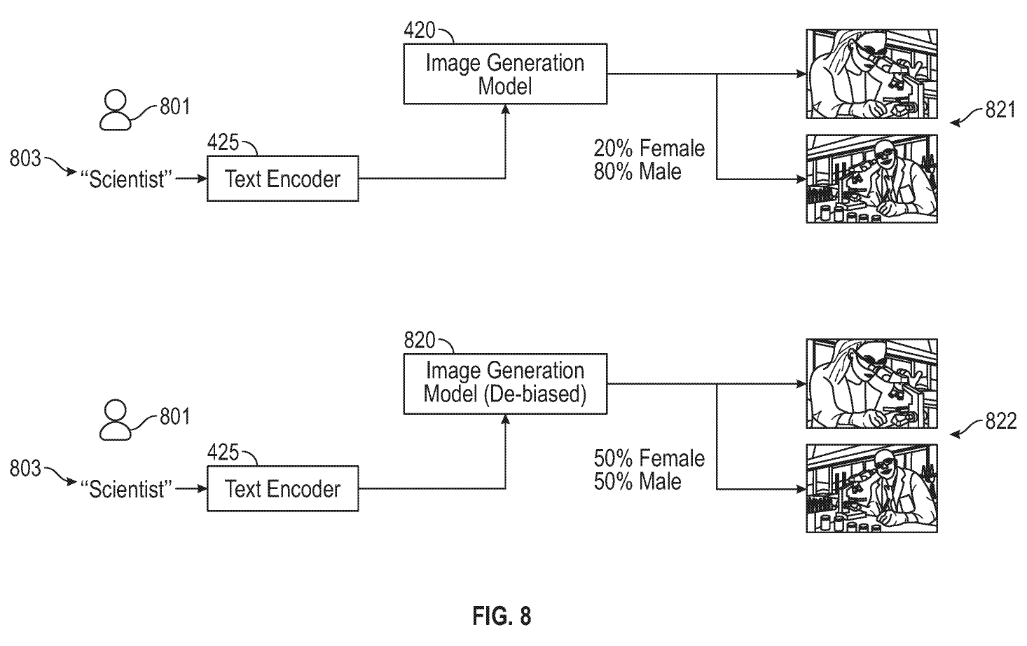

FIG. 8 is a block diagram that compares inference using a baseline model to inference using a de-biased model, according to some embodiments. In this example, a user 801 provides the same input prompt 803 to the baseline image generation model 420 (described above with reference to FIG. 4) and to a de-biased image generation model 820. The de-biased image generation model 820 may be, for example, the refined image generation model 620 described above with respect to FIG. 6, after one or more iterations of fine-tuning process 700 described above with respect to FIG. 7. The input prompt 803 is encoded by text encoder 425 and provided as input to the different models, resulting in different outputs, namely generated image output 821 from the baseline image generation model 420 and generated image output 822 from the de-biased image generation model 820.

As shown in the example of FIG. 8, the baseline image generation model 420 generates images of female and male scientists with a heavy bias towards male scientists (20% female, 80% male) when asked to generate a “scientist” image without indicating the gender. In other words, the image generation model 420 is biased towards male scientists and generates both genders at dissimilar probabilities.

As further shown in the example of FIG. 8, the de-biased image generation model 820 has learned (after one or more iterations of fine-tuning) to generate images of female and male scientists in balanced proportion (~50% female, ~50% male) when asked to generate a “scientist” image without indicating the gender. In other words, the de-biased image generation model 820 is not biased towards a male or female scientist and generates both genders with similar probability.

### REFERENCES

Radford, Alec, et al. "Learning transferable visual models from natural language supervision." International conference on machine learning. PMLR, 2021.

Heusel, Martin, et al. "Gans trained by a two time-scale update rule converge to a local nash equilibrium." Advances in neural information processing systems 30 (2017).

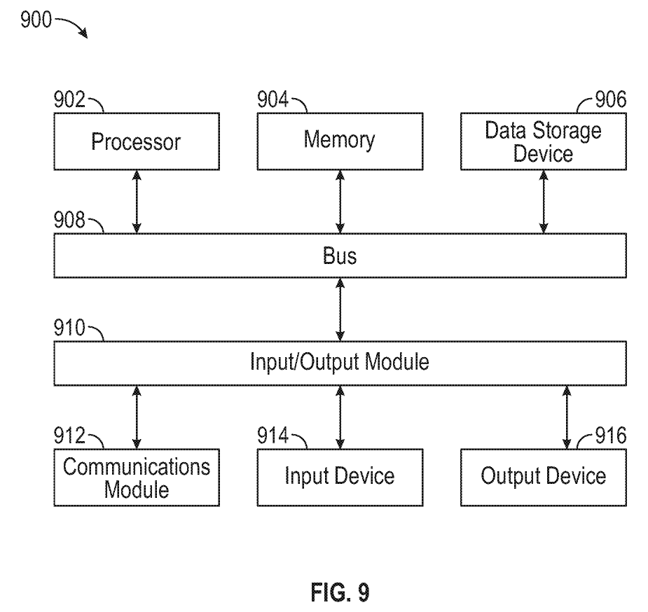

FIG. 9 is a block diagram illustrating an exemplary computer system 900 with which aspects of the subject technology can be implemented. In certain aspects, the computer system 900 may be implemented using hardware or a combination of software and hardware, either in a dedicated server, integrated into another entity, or distributed across multiple entities. As a non-limiting example, the computer system 900 may be one or more of the servers 130 and/or the client devices 110.

Computer system 900 includes a bus 908 or other communication mechanism for communicating information, and a processor 902 coupled with bus 908 for processing information. By way of example, the computer system 900 may be implemented with one or more processors 902. Processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 900 can include, in addition to hardware, code that creates an execution environment for the computer program in question, e.g., code that constitutes processor firmware, a protocol stack, a database management system, an operating system, or a combination of one or more of them stored in an included memory 904, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 908 for storing information and instructions to be executed by processor 902. The processor 902 and the memory 904 can be supplemented by, or incorporated in, special purpose logic circuitry.

The instructions may be stored in the memory 904 and implemented in one or more computer program products, i.e., one or more modules of computer program instructions encoded on a computer-readable medium for execution by, or to control the operation of, the computer system 900, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 904 may also be used for storing temporary variable or other intermediate information during execution of instructions to be executed by processor 902.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 900 further includes a data storage device 906 such as a magnetic disk or optical disk, coupled to bus 908 for storing information and instructions. Computer system 900 may be coupled via input/output module 910 to various devices. The input/output module 910 can be any input/output module. Exemplary input/output modules 910 include data ports such as USB ports. The input/output module 910 is configured to connect to a communications module 912. Exemplary communications modules 912 include networking interface cards, such as Ethernet cards and modems. In certain aspects, the input/output module 910 is configured to connect to a plurality of devices, such as an input device 914 and/or an output device 916. Exemplary input devices 914 include a keyboard and a pointing device, e.g., a mouse or a trackball, by which a user can provide input to the computer system 900. Other kinds of input devices 914 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 916 include display devices such as an LCD (liquid crystal display) monitor, for displaying information to the user.

According to one aspect of the present disclosure, the above-described embodiments can be implemented using a computer system 900 in response to processor 902 executing one or more sequences of one or more instructions contained in memory 904. Such instructions may be read into memory 904 from another machine-readable medium, such as data storage device 906. Execution of the sequences of instructions contained in the main memory 904 causes processor 902 to perform the process steps described herein. One or more processors in a multi-processing arrangement may also be employed to execute the sequences of instructions contained in memory 904. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 900 can include clients and servers. A client and server are generally remote from each other and typically interact through a communication network. The relationship of client and server arises by virtue of computer programs running on the respective computers and having a client-server relationship to each other. Computer system 900 can be, for example, and without limitation, a desktop computer, laptop computer, or tablet computer. Computer system 900 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 902 for execution. Such a medium may take many forms, including, but not limited to, non-volatile media, volatile media, and transmission media. Non-volatile media include, for example, optical or magnetic disks, such as data storage device 906. Volatile media include dynamic memory, such as memory 904. Transmission media include coaxial cables, copper wire, and fiber optics, including the wires that comprise bus 908. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 900 reads application data and provides an application, information may be read from the application data and stored in a memory device, such as the memory 904. Additionally, data from the memory 904 servers accessed via a network, the bus 908, or the data storage 906 may be read and loaded into the memory 904. Although data is described as being found in the memory 904, it will be understood that data does not have to be stored in the memory 904 and may be stored in other memory accessible to the processor 902 or distributed among several media, such as the data storage 906.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In some embodiments, the computer-readable media is non-transitory computer-readable media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. §112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A method for training an image generation model, comprising:
receiving a first set of training data comprising a plurality of training images and corresponding image captions;
using the first set of training data, performing a first training process to train the image generation model resulting in a trained image generation model;
defining a plurality of sensitive categories associated with the plurality of training images;
defining a plurality of protected attributes associated with the plurality of training images;
using the plurality of sensitive categories and the plurality of protected attributes, generating a second set of training data that is balanced across at least one of the plurality of protected attributes with respect to at least one of the plurality of sensitive categories; and
using the second set of training data, performing a second training process to de-bias the trained image generation model resulting in a de-biased image generation model.

2. The method of claim 1, wherein the plurality of training images is a first plurality of training images, and generating the second set of training data comprises:
receiving a third set of training data comprising a plurality of refinement images;
annotating the plurality of refinement images with a plurality of tags to associate each image in the plurality of refinement images with at least one sensitive category from the plurality of sensitive categories and at least one protected attribute from the plurality of protected attributes; and
performing a selection operation on the plurality of refinement images resulting in a plurality of balanced images,
wherein the plurality of balanced images are balanced across at least one of the plurality of protected attributes with respect to at least one of the plurality of sensitive categories, and
wherein the second set of training data comprises the plurality of balanced images.

3. The method of claim 2, wherein annotating the plurality of refinement images comprises performing a classification operation on the plurality of refinement images.

4. The method of claim 2, wherein the first set of training data comprises the third set of training data.

5. The method of claim 1, wherein the first set of training data comprises the second set of training data.

6. The method of claim 1, wherein the image generation model is one of a Generative Adversarial Network (GAN), a Variational Autoencoder (VAE), an autoregressive model, a diffusion-based model, or a transformer-based architecture.

7. The method of claim 1, wherein the plurality of sensitive categories comprise one or more of personalities, conditions, actions, income levels, occupations, and socioeconomic status.

8. The method of claim 1, wherein the plurality of protected attributes comprise one or more of gender, skin color, race, ethnicity, age, and religion.

9. A non-transitory computer-readable medium storing a program for training an image generation model, which when executed by a computer, configures the computer to:
receive a first set of training data comprising a plurality of training images and corresponding image captions;
using the first set of training data, perform a first training process to train the image generation model resulting in a trained image generation model;
define a plurality of sensitive categories associated with the plurality of training images;
define a plurality of protected attributes associated with the plurality of training images;
using the plurality of sensitive categories and the plurality of protected attributes, generate a second set of training data that is balanced across at least one of the plurality of protected attributes with respect to at least one of the plurality of sensitive categories; and
using the second set of training data, perform a second training process to de-bias the trained image generation model resulting in a de-biased image generation model.

10. The non-transitory computer-readable medium of claim 9, wherein the plurality of training images is a first plurality of training images, and wherein the program, when executed by the computer, further configures the computer to generate the second set of training data by further configuring the computer to:
receive a third set of training data comprising a plurality of refinement images;
annotate the plurality of refinement images with a plurality of tags to associate each image in the plurality of refinement images with at least one sensitive category from the plurality of sensitive categories and at least one protected attribute from the plurality of protected attributes; and
perform a selection operation on the plurality of refinement images resulting in a plurality of balanced images,
wherein the plurality of balanced images are balanced across at least one of the plurality of protected attributes with respect to at least one of the plurality of sensitive categories, and
wherein the second set of training data comprises the plurality of balanced images.

11. The non-transitory computer-readable medium of claim 10, wherein the first set of training data comprises the third set of training data.

12. The non-transitory computer-readable medium of claim 10, wherein the program, when executed by the computer, further configures the computer to annotate the plurality of refinement images by further configuring the computer to perform a classification operation on the plurality of refinement images.

13. The non-transitory computer-readable medium of claim 9, wherein the first set of training data comprises the second set of training data.

14. The non-transitory computer-readable medium of claim 9, wherein the image generation model is one of a Generative Adversarial Network (GAN), a Variational Autoencoder (VAE), an autoregressive model, a diffusion-based model, or a transformer-based architecture.

15. The non-transitory computer-readable medium of claim 9, wherein the plurality of sensitive categories comprise one or more of personalities, conditions, actions, income levels, occupations, and socioeconomic status, and
wherein the plurality of protected attributes comprise one or more of gender, skin color, race, ethnicity, age, and religion.

16. A system for training an image generation model, comprising:
a processor; and
a non-transitory computer-readable medium storing a set of instructions, which when executed by the processor, configure the system to:
receive a first set of training data comprising a plurality of training images and corresponding image captions;
using the first set of training data, perform a first training process to train the image generation model resulting in a trained image generation model;
define a plurality of sensitive categories associated with the plurality of training images;
define a plurality of protected attributes associated with the plurality of training images;
using the plurality of sensitive categories and the plurality of protected attributes, generate a second set of training data that is balanced across at least one of the plurality of protected attributes with respect to at least one of the plurality of sensitive categories; and
using the second set of training data, perform a second training process to de-bias the trained image generation model resulting in a de-biased image generation model.

17. The system of claim 16, wherein the plurality of training images is a first plurality of training images, and wherein the instructions, when executed by the processor, further configures the system to generate the second set of training data by further configuring the system to:
receive a third set of training data comprising a plurality of refinement images;
annotate the plurality of refinement images with a plurality of tags to associate each image in the plurality of refinement images with at least one sensitive category from the plurality of sensitive categories and at least one protected attribute from the plurality of protected attributes; and
perform a selection operation on the plurality of refinement images resulting in a plurality of balanced images,
wherein the plurality of balanced images are balanced across at least one of the plurality of protected attributes with respect to at least one of the plurality of sensitive categories, and
wherein the second set of training data comprises the plurality of balanced images.

18. The system of claim 17, wherein the first set of training data comprises the third set of training data.

19. The system of claim 17, wherein the instructions, when executed by the processor, further configure the system to annotate the plurality of refinement images by further configuring the system to perform a classification operation on the plurality of refinement images.

20. The system of claim 16, wherein the first set of training data comprises the second set of training data.
